(19) United States
(12) Patent Application Publication
(10) Pub. No.: US 2011/0250450 A1
(43) Pub. Date: Oct. 13, 2011

(54) EXTRUDED COMPONENT WITH ANTIMICROBIAL GLASS PARTICLES

(75) Inventors: Vinesh Naik, Wilkes Barre, PA (US); Jeffery B. Keane, Darien, CT (US)

(73) Assignee: NOBLE FIBER TECHNOLOGIES, LLC, Scranton, PA (US)

(21) Appl. No.: 13/006,686

(22) Filed: Jan. 14, 2011

Related U.S. Application Data
(60) Provisional application No. 61/295,403, filed on Jan. 15, 2010.

(51) Int. Cl. D02G 3/36; C08K 3/08; C08L 23/06; D02G 3/02

(52) U.S. Cl. 428/374; 428/373; 428/401; 523/122

(57) ABSTRACT

An extruded component formed from an extruded material having antimicrobial components is disclosed. The extruded material may be formed from polymers and formed into a generally elongated shape. The antibacterial components may be included within at least a portion of the material forming the extruded component. The extruded component may be a filament and may include silver glass particles. In some embodiments, the extruded component may be a single component system, a bi-component system, or a tri-component system.

### CROSS-REFERENCE TO RELATED APPLICATION

This patent application claims the benefit of U.S. Provisional Patent Application No. 61/295,403, filed Jan. 15, 2010, which is incorporated by reference in its entirety.

### FIELD OF THE INVENTION

This invention is directed generally to antimicrobial materials, and more particularly to antimicrobial materials formed as filaments.

### BACKGROUND

Many filaments are formed from extrusion for a variety of uses. The filaments are often coated with a dye to create a filament of a chosen color. The filaments may be combined with each other to form a fabric or other useful object. Filaments and fabrics have been coated with antimicrobial materials to create an item useful in regulating microbes. The antimicrobial materials are typically coated on the outer surface of the filaments.

### SUMMARY OF THE INVENTION

This invention is directed to an extruded component including one or more antimicrobial components incorporated within the extruded component during the manufacturing process. The antimicrobial components may be sized relative to a cross-sectional dimension of the extruded component such that the antimicrobial components are mixed within the material forming the antimicrobial components. The extruded component may be a filament. In at least one embodiment, the filament may have a generally cylindrical shape and may have an outer diameter less than about ten microns. The antimicrobial components may be, but are not limited to being, silver, aluminum, copper, and zinc. These and other embodiments are described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a perspective view of an extruded component.

FIG. 2 is a cross-sectional view of an alternative embodiment of the extruded component, a bi-component filament, taken along section line 2-2 in FIG. 1.

FIG. 3 is a cross-sectional view of an alternative embodiment of the extruded component, a tri-component filament, taken along section line 3-3 in FIG. 1.

FIG. 4 is a cross-sectional view of an alternative embodiment of the bi-component filament of FIG. 2.

FIG. 5 is a cross-sectional view of an alternative embodiment of the bi-component filament of FIG. 2.

FIG. 6 is a cross-sectional view of an alternative embodiment of the tri-component filament of FIG. 3.

FIG. 7 is a cross-sectional view of an alternative embodiment of the tri-component filament of FIG. 3.

### DETAILED DESCRIPTION OF THE INVENTION

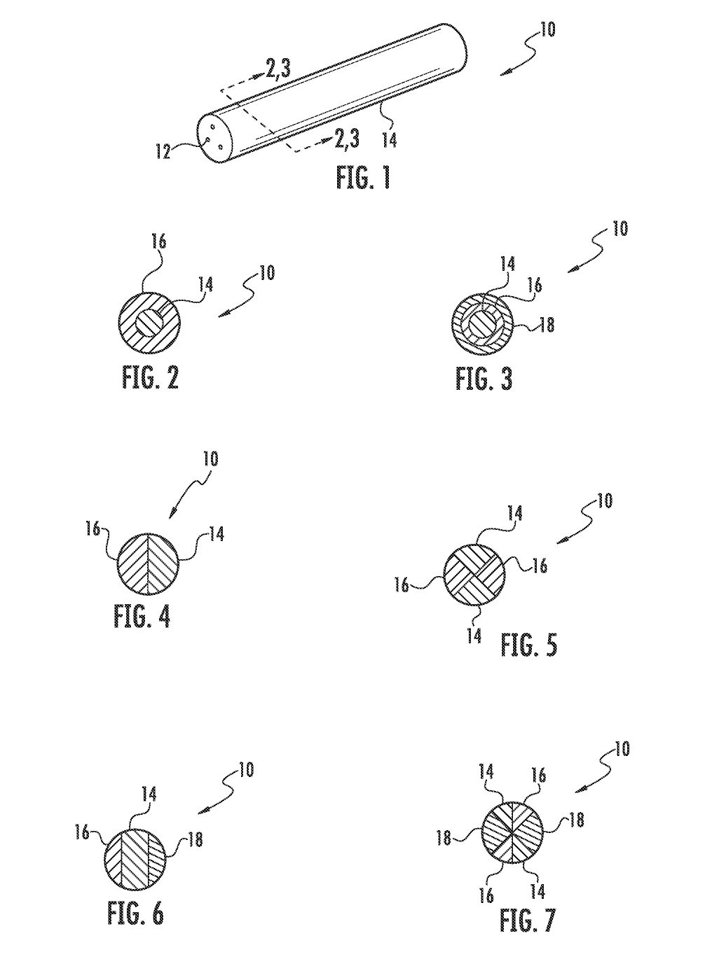

As shown in FIGS. 1-7, this invention is directed to an extruded component 10 including one or more antimicrobial components 12 incorporated within the extruded component 10 during the manufacturing process. The antimicrobial components 12 may be sized relative to a cross-sectional dimension of the extruded component 10 such that the antimicrobial components are mixed within the material forming the antimicrobial components 12. The extruded component 10 may be a filament. In at least one embodiment, the filament may have a generally cylindrical shape and may have an outer diameter less than about ten microns. The antimicrobial components 12 may be, but are not limited to being, silver, aluminum, copper, and zinc.

The extruded component 10 may include an extruded material forming a generally elongated shape and may include an antibacterial component formed from silver glass in the extruded materials. The extruded component 10 may be a filament having any appropriate configuration. In particular, extruded component may be a single component, as shown in FIG. 1, a bi-component, as shown in FIG. 2, a tri-component, as shown in FIG. 3, or any appropriate configuration. The bi-component of FIG. 2 may include a core component 14 forming a generally elongated shape and a second component 16 supporting the core 14. The core component 14 may include silver glass particles. In at least one embodiment, as shown in FIG. 2, the second component 16 may form a sleeve surrounding the core 14 and may be positioned radially outward from the core 14. In one embodiment, the core 14 may be positioned concentrically within the second component 16. In another embodiment, as shown in FIG. 4, the core component 14 and the second component 16 may each form a half of a cross-section of the extruded component 10. In yet another embodiment, as shown in FIG. 5, the core component 14 and the second component 16 may each form portions of a cross-section of the extruded component 10. More specifically, the core component 14 and the second component 16 may each form one or more pie shaped pieces that together form a filament. The core component 14 and the second component 16 may be positioned in an alternating configuration. By changing the configuration of the extruded component 10, the core component 14 including the one or more antimicrobial components 12 may be positioned to provide the most effective, efficient use of the antimicrobial properties of the antimicrobial components 12.

In an alternative embodiment, as shown in FIG. 3, the extruded component 10 may be formed from a tri-component, such that the extruded component 10 includes three components. The tri-component may include an appropriate cross-sectional layout of the sections. In at least one embodiment, as shown in FIG. 3, the sections may be concentric and include the core component 14, a second component 16 and a third component 18. In one embodiment, the core 14, may be positioned concentrically within the second component 16, which may be positioned concentrically within the third component 18. In another embodiment, as shown in FIG. 6, the sections may be positioned adjacent to each other, and in yet another embodiment, as shown in FIG. 7, the sections may be pie shaped pieces forming a filament. By changing the configuration of the extruded component 10, the core component 14, including one or more antimicrobial components 12, may be positioned to provide the most effective, efficient use of the antimicrobial properties of the antimicrobial components 12.

The extruded component 10 may be formed from polymers, such as, but not limited to, polyethylene pellets. The extruded component 10 may be formed from materials, such as, but not limited to, polymers including Nylon 6,6; Nylon 6, Polyester, Kevlar, Nomex, and other appropriate materials. The Nylon 6,6 may be extruded at temperatures of between about 280 degrees Celsius and about 300 degrees Celsius. The polyethylene pellets may include a dye. Various colored dyes may be used depending on the desired color. The antimicrobial component 12 may be mixed with the polymer during manufacturing of the filament. In at least one embodiment, the silver glass particles may be mixed with the polyethylene pellets. In at least one embodiment, the silver glass particles with dye are positioned within the polyethylene pellets and may be used to form a master batch. The master batch may be combined with polyethylene pellets such that the master batch forms less than ten percent of the mixture forming the extruded material 10. As such, a viscosity of the mixture is reduced by less than about ten percent. The starting viscosity may be about 0.7, which may then reduced to about 0.62 to 0.64 upon the addition of the master batch.

The foregoing is provided for purposes of illustrating, explaining, and describing embodiments of this invention. Modifications and adaptations to these embodiments will be apparent to those skilled in the art and may be made without departing from the scope or spirit of this invention.

We claim:

1. An extruded component, comprising:
an extruded material forming a generally elongated shape; and
wherein the extruded material include at least one antibacterial component formed from silver glass.

2. The extruded component of claim 1, wherein the extruded component is a bi-component.

3. The extruded component of claim 2, wherein the second component forms a sleeve surrounding the core and is positioned radially outward from the core.

4. The extruded component of claim 2, wherein the core component and the second component each form a half of a cross-section of the extruded component.

5. The extruded component of claim 2, wherein the core component and the second component each form portions of a cross-section of the extruded component.

6. The extruded component of claim 2, wherein the extruded component is a triple component.

7. The extruded component of claim 1, wherein the extruded component is formed from polyethylene pellets.

8. The extruded component of claim 1, wherein the extruded component is formed from polyethylene pellets that include dye, and wherein a viscosity of the polyethylene is decreased less than ten percent upon the addition of silver glass particles.

9. The extruded component of claim 1, wherein the extruded component is less than about ten microns in diameter, and wherein the extruded material is formed from less than about ten percent of a master batch.

10. An extruded component, comprising:
a core component forming a generally elongated shape; and
a second component supporting the internal core;
wherein the core component includes silver glass particles.

11. The extruded component of claim 10, wherein the extruded component is a bi-component.

12. The extruded component of claim 11, wherein the second component forms a sleeve surrounding the core and is positioned radially outward from the core.

13. The extruded component of claim 11, wherein the core component and the second component each form a half of a cross-section of the extruded component.

14. The extruded component of claim 11, wherein the core component and the second component each form portions of a cross-section of the extruded component.

15. The extruded component of claim 11, wherein the extruded component is a triple component.

16. The extruded component of claim 10, wherein the extruded component is formed from polyethylene pellets.

17. The extruded component of claim 16, wherein a viscosity of the polyethylene is decreased less than ten percent upon the addition of silver glass particles.

18. The extruded component of claim 10, wherein the extruded component is formed from polyethylene pellets that include dye.

19. The extruded component of claim 10, wherein the extruded component is less than about ten microns in diameter.

20. The extruded component of claim 10, wherein the extruded material is formed from less than about ten percent of a master batch.
